(19) United States
(12) Patent Application Publication
(10) Pub. No.: US 2003/0123742 A1
(43) Pub. Date: Jul. 3, 2003

(54) Image compression

(75) Inventors: Debin Zhao, Harbin (CN); Y.K. Chan, Kowloon (HK); Wen Gao, Harbin (CN)

Correspondence Address: HESLIN ROTHENBERG FARLEY & MESITI PC, 5 COLUMBIA CIRCLE, ALBANY, NY, 12203, US

(73) Assignee: City University of Hong Kong, Kowloon Tong Kowloon (HK)

(21) Appl. No.: 10/161,543

(22) Filed: Jun. 3, 2002

(30) Foreign Application Priority Data
Jul. 20, 2001 (HK) 01105139.0

(51) Int. Cl. G06K 9/36

(52) U.S. Cl. 382/240

(57) ABSTRACT

A Low-complexity and Low-memory Entropy Coder is proposed for image compression. It includes zerotree coding, followed by the use of Golomb-Rice codes to code the result in a VLC/VLI manner. The result is a complexity similar to that of JPEG coding. The proposed algorithm does not require use of any Huffman table, significant/insignificant list or arithmetic coding and therefore its memory requirement is minimized with respect to any known image entropy coder. Experimental results are given of the use of the proposed coder. The proposed coder is suitable for parallel processing implementation, ROI (Region Of Interest) coding and as a universal entropy coder for DCT and DWT.

### FIELD OF THE INVENTION

The present invention relates to methods and apparatus for compressing images.

### DESCRIPTION OF THE PRIOR ART

Recent impressive advances in image compression are mainly attributable to two factors: transform techniques and entropy coding of transformed coefficients. The Discrete Cosine Transform (DCT) and Discrete Wavelet Transform (DWT) are still the dominant transform techniques applied to current applications although LPPRFB (Linear Phase Perfect Reconstruction FilterBanks) [1] is sometimes used. As for entropy coding, static Huffman codes are used in most popular compression standards such as JPEG [2], MPEG-1/2 [3], [4], MPEG4 [5]-[7] and H261/3 [8], [9]. In the quest for higher compression efficiency, arithmetic coding has been applied to DCT and DWT. There are several representatives of such state of the art coders, such as EZDCT (Embedded Zerotree DCT coding) [10], [11], EZHDCT (Embedded Zerotree coding in Hierarchical DCT) [12], EZW (Embedded Zerotree Wavelet coding) [13], SPIHT (Set Partition In Hierarchical Trees) [14], ZTE (ZeroTree Entropy coding) [15], and EBCOT (Embedded Block Coding with Optimized Truncation) [16]. These coders provide very high compression efficiency in terms of Peak Signal-to-Noise Ratio (PSNR) versus required bits-per-pixel (bpp). The disadvantage of these coders is higher computational complexity and additional memory requirements. The higher computational complexity and additional memory requirements of an arithmetic coder over the Huffman entropy coder is an extra burden, and it has been pointed out that even static Huffman tables can cause a bottleneck in hardware implementation [17]. In fact, computational complexity and memory requirements are important constraints in many image compression applications. This is especially true for mass-market consumer products such as printers or digital cameras with their need to maintain low cost.

### SUMMARY OF THE INVENTION

The present invention aims to provide encoding methods and devices which have competitive compression efficiency and yet require lower computational complexity and lower memory than most conventional coders, resulting in lower cost implementation.

In general terms the present invention proposes two-stage coding, which in practise are closely related and may share computing steps. In a first stage, ZeroTree coding is performed (ZTC). In a second stage, the resulting data is encoded using Golomb-Rice codes (GRC). The motivation for employing this combination of techniques is the present inventors' realisation that transformed image coefficients can be effectively and efficiently compressed by ZTC and GRC. Operationally, ZTC and GRC is tightly coupled and both coding is performed in a single pass. In addition, remaining coefficients have statistical properties well-suited to coding using GRC.

Specifically, in a first expression the present invention proposes a method for compression of a digital image, the method comprising:

transforming the image into a data structure having a parent-child relationship with a plurality of sub-bands;

zerotree encoding the data structure to produce zerotree coded data comprising zerotree symbols representing zerotrees in the data structure and symbols representing the values of remaining elements in the data structure; and

secondary encoding of the values of the remaining elements in the zerotree coded data using Golomb-Rice codes.

In a second expression the invention provides an encoder device for compression of a digital image, the encoder comprising:

a filter for transforming the image into a data structure having a parent-child relationship with a plurality of subbands; and

an encoder for:

zerotree encoding the data structure to produce zerotree coded data comprising zerotree symbols representing zerotrees in the data structure and symbols representing the values of remaining elements in the data structure; and

secondary encoding of the values of the remaining elements in the zerotree coded data using Golomb-Rice codes.

In particular, the zerotree coded data generally includes symbols representing zerotrees and “remaining coefficients” which are transformed values of non-zero elements of the data structure. The Golomrb-Rice codes are used in the present invention to convert the remaining coefficients in a way analogous to that used JPEG VLCNLI (Variable Length CodesNariable Length Integer). However, in the present invention G-R codes are used instead of JPEG Huffman tables since this results in low complexity and low memory requirements. This is because G-R codes are known to be extremely simple to implement both in software and hardware [20], [21].

Furthermore, the secondary coding preferably only involves FS (fundamental sequence) in G-R codes (G-R FS) without a need to use sample splitting [19] or parameter estimation [21]. As such, it is truly a low complexity and low memory entropy coder with competitive compression performance.

Preferably the transformation which produces the data structure is a discrete cosine transform, or a discrete wavelet transform.

After this transformation, all coefficients are quantized. Quantization is a process whereby the coefficients are reduced in precision for higher compression efficiency without significantly losing visual image quality. The subsequent zerotree coding is then selected to be a coding such that a zerotree of the data structure is defined as a tree in which all of the elements in it are zero. In our zerotree coding algorithm, in contrast to EZC, the zerotree coding can be done in a single pass, rather than as a series of steps at decreasing magnitude levels (i.e. multiple passes on a bit-plane-by-bit-plane basis).

Furthermore, the transformation used to construct the data structure preferably includes a decorrelation step, which may be performed by differential pulse code modulation.

A summary of the advantages arising from preferred features of the invention is as follows:

1) ZTC coding of zerotrees in a single pass,

2) G-R codes are used instead of Huffman coding or arithmetic coding, so the computational complexity is significant reduced:

3) The memory requirement is minimized because the embodiment does not require any statistical table or significant/insignificant list.

4) The embodiment is receptive to different quantization schemes. For example, the embodiment can be used with uniform and deadzone quantization or any other quantization such as JPEG quantization.

5) The embodiment can be applied to transformed blocks concurrently as it only requires the information within a block and does not require any run time statistics.

6) The embodiment can be taken as a universal entropy coder since it can be applied to DCT, DWT, LPPRFB, etc.

7) The embodiment can support ROI (Region Of Interest) coding as a consequence of 3) and 4). ROI is a means to provide better visual quality in certain areas of a compressed image. For example, it is desirable to have better visual quality in the foreground and lesser visual quality in the background. For example, JPEG2000 supports ROI.

In terms of usage, the embodiment can be applied to DCT and LPPRFB directly as both transformation schemes are typically block-based. It can also be taken as the entropy coder for DWT after reorganizing its coefficients into transformed blocks [1], [22].

### BRIEF DESCRIPTION OF THE FIGURES

An embodiment of the invention will now be described for the sake of example only with reference to the following figures, in which:

FIG. 1 shows a known three-scale parent-child structure which can be used by the embodiment;

FIG. 2 is an algorithmic description of the embodiment;

FIG. 3, which is composed of FIG. 3(a) and FIG. 3(b), shows an array of 8×8 three-scale transform block coefficient values which is used in a detailed example of the application of the embodiment;

FIG. 4 shows a data structure from a block of a complex area of the standard “Lena” image;

FIG. 5 shows a data structure from a block of a smooth area of the standard “Lena” image; and

FIG. 6 illustrates schematically the encoding of the data structure of FIG. 5 according to an embodiment of the invention.

### DETAILED DESCRIPTION OF THE EMBODIMENT

The rest of the paper is organised as follows. In Section 1, we give a detailed explanation on the embodiment by zero tree coding (ZTC), coding of remaining coefficients, algorithmic description and computational complexity/memory requirement. The coding of remaining coefficients is illustrated with coefficient bucketing, category statistical characteristics and Golomb-Rice codes. Section 2 provides the experimental results and performance comparisons.

1. Explanation of the Embodiment

In this section, the embodiment is presented in terms of ZTC, coding of remaining coefficients, algorithmic description and computational complexity/memory requirement. ZTC exploits the zerotree structure that exists in DCT and DWT transformed coefficients to reduce the number of bits required to represent these zerotrees. After ZTC coding of these zerotrees, there are still remaining coefficients to be coded. Our coding of the remaining coefficients is uses two components: referred to here as G-R_FS (derivation of a Golomb-Rice code) and VLI. Algorithmic description of the embodiment is then provided. The last subsection provides a brief analysis of its computational complexity and memory requirement of the embodiment.

A. Zerotree Coding

Exploiting Zerotree structure is a proven approach for coding DCT/DWT coefficients because of its superior compression performance. Variants of coding schemes that exploits Zerotree structure include [10], [11] for DCT and [13], [14], [15] for DWT. The zerotree structure takes advantage of the principle that if the quantized coefficient at coarse scale is insignificant, then all coefficients on the same orientation at the same spatial location at finer scale are also likely to be insignificant. Our proprietary ZTC also exploits Zerotree structure. Our ZTC is used to reduce the number of bits required to represent these zerotrees.

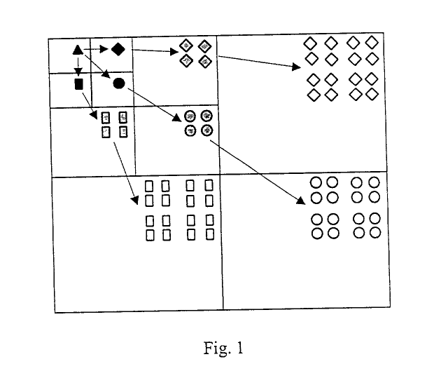

The data structure used in the present embodiment is shown in FIG. 1. This is generated according to known methods using a discrete cosine transform or a discrete wavelet transform. Subsequently, a simple DPCM scheme (Relative DC=Current DC−Previous DC) is applied to decorrelate the neighboring DC coefficients in the case of DCT or LL subband in the case of DWT. The result is quantised according to a known scheme.

To perform the zerotree encoding, the significant/insignificant decision is made depending on whether a quantized coefficient is zero or non-zero. That is, an element of the data structure is considered to be insignificant if, and only if, it is zero.

All zerotrees are extracted and coded by ZTC. The coefficient scanning, tree growing and coding are done in one pass instead of multiple passes on a bit-plane-by-bit-plane basis such as used in EZW [13] and SPIHT [14]. Thus we obtain advantages in terms of low complexity and low memory requirement.

The values of the elements of the data structure which are not parts of zero-trees (i.e. the elements which the values of which are not defined by the zerotree symbols) are referred to as “remaining coefficients”. It should be noted that the coding of ZTC and the remaining coefficients is closely coupled (meaning that the complete coding of transformed coefficients are all done in one single pass).

B. Coding of Remaining Coefficients

Coding of remaining coefficients are performed by using Golomb-Rice coding. The motivation for employing G-R codes is that it is the inventors' realization that both DCT and DWT remaining coefficients have statistical properties well-suited to coding using Golomb-Rice coding.

This subsection explains how the remaining coefficients are structured and coded by the following parts: coefficient bucketing, category statistical characteristics and Golomb-Rice codes.

Coefficient bucketing is used to break down the remaining coefficients into two separate components as Category and VLI for higher compression efficiency. The desirable statistical characteristics of Category are then given. Finally, the simplicity and efficiency of G-R codes for coding Category is illustrated.

1) Coefficient Bucketing: A known coding technique for remaining coefficients (e.g. used for example in JPEG, see [2]) is to allocate the coefficients into different Categories (“buckets”). The buckets are labelled by a number m (m=0, . . . N, where the remaining coefficients are in the range −(2^{N}−1) to 2^{N}−1), which is the number of bits required to express that value. For example, for m=0, the category may just be the element “0”. For m not equal to 1, the m-th category may be all the 2^{m} values in the ranges −(2^{m}−1) to −2^{m-1} and 2^{m-1} to 2^{m}−1. The remaining coefficient is then encoded as a first string of (m+1) bits composed of m zeros followed by a 1, together with a second string having m bits and specifying the value within that category (VLI). Note that no VLI is required for the category m=1, since it has only one member, that is “0”.

For the first four categories this can be expressed as follows:

| | | | Number |
|---|---|---|---|
| | | Range of number | of bits coded in |
| | | represented by | VLI to represent actual |
| m | Bit pattern for category | category and VLI | numerical value |
| 0 | 1 | 0 | Not Required |
| 1 | 01 | +/−1 | 1 bit = x |
| 2 | 001 | +/−2,3 | 2 bits = xx |
| 3 | 0001 | +/−4,5,6,7 | 3 bits = xxx |

For example, for the m=2 category, the bit pattern is always equal to 001. All members of this category have a 2 bit VLI, for example:

| Bit Pattern | VLI | | Represented Value |
|---|---|---|---|
| 001 | 00 | = | −3 |
| 001 | 01 | = | −2 |
| 001 | 11 | = | +2 |
| 001 | 10 | = | +3 |

Therefore, for coding the remaining coefficients, which are zeros, positive integers and negative integers, we always use

1 to code the values 0

01 x to code the values +/−1

001 xx to code the values +/−2,3

0001 xxx to code the values +/−4,5,6,7

00001 xxxx to code the values +/−8,9,10,11,12,13,14,15.

Coding the remaining coefficient as two components enables higher compression efficiency to be achieved than the straightforward coding of quantized coefficients alone. Table I is an example of the bucketing strategy used in JPEG. There are two columns in Table I referred as Category and its associated coefficient values. The bits required to locate a coefficient in the coefficient bucket are indicated by its associated Category (JPEG-VLI).

Note that in JPEG, Category is coded using Huffman tables. This is known as JPEG-VLC. This coefficient bucketing technique is also used in the present embodiment for coding the remaining coefficients. Also, the VLI aspect of JPEG-VLI is used also in this embodiment. However, in contrast to JPEG-VLC, the present invention proposes that the category is encoded by G-R codes, rather than by Huffman codes, resulting in low complexity and low memory.

Table I
COEFFICIENT BUCKETS

| Category | Coefficient values |
|---|---|
| 0 | 0 |
| 1 | −1, 1 |
| 2 | −3˜−2, 2˜3 |
| 3 | −7˜−4, 4˜7 |
| 4 | −15˜−8, 8˜15 |
| 5 | −31˜−16, 16˜31 |
| 6 | −63˜−32, 32˜63 |
| 7 | −127˜−64, 64˜127 |
| 8 | −255˜−128, 128˜255 |
| 9 | −511˜−256, 256˜511 |

2) Category Statistical Characteristics: As stated in the previous paragraph, the remaining coefficients are decomposed into two separate components as Category and VLI. It is intended to show in here that Category has a very desirable probability distribution that is closely approximated by the probability distribution 2⁻ⁱ(i=1,2, . . . ,n) regardless of quantization step and transform scheme (DCT or DWT) used.

For a better description on the statistical characteristics of Category, two mathematical measurements are introduced: entropy and standard deviation. The entropy is the average code length per symbol. It provides a fundamental lower bound for the compression that can be achieved for that source. Therefore, the entropy is a very convenient measure of the performance of a coding scheme. The standard deviation measures the spread or dispersion of the probability distribution. If the distribution of a source is tightly clustered about its mean value, then the standard deviation will be small. On the other hand, it will be large whenever its probability is spread out over a wide interval.

The following two experiments attempt to show that the probability distribution of Category is highly invariant to different quantization steps and across transform schemes by a small standard deviation of its entropy. Furthermore, the resulting probability distribution from test images approximates closely to 2⁻ⁱ(i=1,2, . . . ,n). This approximation is validated by their respective entropy values. In both experiments, the test image is greyscale 512×512 Lena image. The uniform+deadzone quantization [23] is applied. The quantization step (qstep) is set from 10 to 50 which covers a wide range of useful decompressed image quality. The deadzone width is set to be 40% larger than the regular step size because this deadzone setting consistently provides good compression efficiency that is highly invariant to different quantization steps and across DWT [24] and DCT transforms.

Experiment One (DCT): This is to perform an 8×8 DCT on the known Lena image, and to use quantization techniques with various quantization steps to quantize the DCT coefficients. The bucketing strategy shown in Table I is applied to the remaining coefficients. The probability distribution of Category is listed in Table II(a). The resulting average entropy of Category is 1.88 and the standard deviation is 0.057.

TABLE II
PROBABILITY DISTRUBUTION OF CATEGORY
(a) DCT with uniform + deadzone quantization

| DCT | Quantization step | | | | |
|---|---|---|---|---|---|
| Category | 10 | 15 | 20 | 30 | 50 |
| 0 | 49% | 47% | 47% | 47% | 49% |
| 1 | 28% | 30% | 28% | 28% | 29% |
| 2 | 13% | 13% | 15% | 15% | 14% |
| 3 | 6% | 6% | 6% | 6% | 5% |
| 4 | 3% | 3% | 3% | 3% | 2% |
| 5 | 1% | 1% | 1% | 1% | 0.3% |
| 6 | 0.6% | 0.4% | 0.3% | 0.1% | 0 |
| 7 | 0.01% | 0 | 0 | 0 | 0 |
| Entropy | 1.91 | 1.91 | 1.92 | 1.91 | 1.77 |
| G-R_FS | 1.93 | 1.94 | 1.95 | 1.94 | 1.81 |
| Code Length | | | | | |

(b) DWT with uniform + deadzone quantization

| DWT | Quantization step | | | | |
|---|---|---|---|---|---|
| Category | 10 | 20 | 30 | 40 | 50 |
| 0 | 52% | 49% | 50% | 50% | 51% |
| 1 | 27% | 28% | 29% | 29% | 29% |
| 2 | 13% | 15% | 14% | 14% | 13% |
| 3 | 5% | 5% | 5% | 5% | 4% |
| 4 | 2% | 2% | 2% | 1% | 1% |
| 5 | 1% | 1% | 1% | 0.7% | 0.7% |
| 6 | 0.3% | 0.4% | 0.3% | 0.2% | 0.2% |
| 7 | 0.2% | 0.1% | 0.1% | 0.1% | 0.1% |
| Entropy | 1.82 | 1.87 | 1.85 | 1.78 | 1.73 |
| G-R_FS | | | | | |
| Code Length | 1.85 | 1.90 | 1.89 | 1.81 | 1.75 |

Experiment Two (DWT): This is to six-scale wavelet decomposition on Lena image using 9-7 biorthogonal spline filters of Daubechies [25]. In this experiment too we use various quantization steps to quantize the DVVT coefficients. The same bucketing strategy is applied to the remaining coefficients. The probability distribution of Category is listed in Table II(b). The resulting average entropy of Category is 1.81 and the standard deviation is 0.050.

It can be seen that the entropy of Category for both DCT and DWT is only a few percent difference to the entropy of 2⁻ⁱ(i=1,2, . . . ,n) when n=8.

From the entropy of Category and its small standard deviation, we can conclude that the probability distribution of Category is highly invariant to different quantization steps and across different transform schemes. Furthermore, the resulting probability distribution from the test image is closely approximated by 2⁻ⁱ(i=1,2, . . . ,n). Similar statistical characteristics have also been obtained on other test images, such as Barbara and Airplane images.

3) G-R Codes: When computational complexity and memory requirement is not an issue, Category is best coded with arithmetic coding to highest achievable compression efficiency. But in applications where very low complexity is a primary consideration, arithmetic coding may not be an affordable option. G-R codes are known due to their application in the JPEG-LS standard for lossless and near-lossless compression of continuous-tone still images [20], [21]. Despite being extremely simple to implement both in software and hardware, the coding performance of the G-R coding technique proposed in [20] proved to be, in practice, within a few percent of some more complex arithmetic-coding-based techniques for lossless and near-lossless image compression [21].

The two major components of G-R codes are the fundamental sequence (FS) and sample splitting. FS is a comma code with the property that a value m has a corresponding codeword that is made up of m “0”s followed by a “1” (or, in a trivial variation of the algorithm, m “1”s followed by a “0”). Because each codeword is uniquely defined by simply knowing its input value, codebooks are not required. FS is optimal for coding source with the probability distribution of 2⁻ⁱ(i=1,2, . . . ,n). Sample splitting is a technique that assumes that the K least significant bits for an input are random, and therefore, cannot be compressed. For N bits data, the remaining N−K most significant bits are coded using FS code. The sample splitting in JPEG-LS is performed using parameter estimation.

From the statistical characteristics of Category in Experiment One and Two, it can be easily found that G-R_FS can be applied to code Category efficiently without the need to further use sample splitting or parameter estimation.

In order to measure the G-R_FS coding efficiency for Category, we define code efficiency as the ratio:

$$η = \frac{H}{\overline{L}} , \qquad ( 1 )$$

where H is the entropy of a source and \overline{L} is the average code length for the. coding scheme. In this case, H is the entropy of Category. The average code length (\overline{L}) using G-R_FS can be obtained from

$$\overline{L} = {\sum }_{i = 0}^{n - 1} {P}_{i} \times ( i + 1 ) , \qquad ( 2 )$$

where Pᵢ is the Category probability of i and (i+1) is its corresponding FS code length.

From Table II, we can obtained that

$${\overline{η}}_{DCT} = \frac{1}{5} {\sum }_{m = 0}^{4} {η}_{dct} ( m ) = 98.4 \%$$

and

$${\overline{η}}_{WT} = \frac{1}{5} {\sum }_{m = 0}^{4} {η}_{wt} ( m ) = 98.4 \% .$$

Therefore, the coding efficiency of G-R_FS on Category is 98.4% for both DCT and DWT.

C. Algorithmic Description of the Embodiment

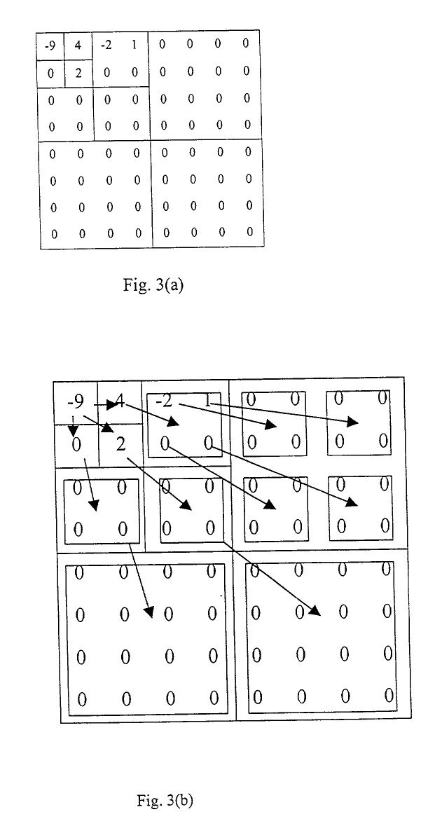

In the following, a simple example will be used to highlight the procedure of the embodiment. Consider the simple 3-scale transform of an 8×8 block, the array of coefficient values is shown in FIG. 3(a). The processing of the embodiment operating on this coefficient block is listed as follows, with reference to the version of FIG. 3(a) which is shown in FIG. 3(b).

We start at the upper left corner of FIG. 3(b), with the coefficient “−9”. We represent this by GRC as the category (m=4). Thus the output is 00001 to indicate this category (i.e. 4 zeros and a 1, a total of 4+1 bits), followed by 4 bits which is the VLI. In the case of −9, the VLI is 0110 which is 6 in decimal notation, indicating that −9 is in position 6 in an arbitrary list of the 16 elements (+/−8, 9, 10, 11, 12, 13, 14, 15) in the m=4 category.

We then output 1, to indicate that not all of the descendants (according to the family defined by FIG. 1) of the top left element “−9” of the data structure, are zero.

We now treat the three direct descendants (i.e. first generation descendants) of the top left element “−9” of the data structure of FIG. 3(b). That is the elements “0”, “2”, and “4”.

For the element “0”, all of its descendants are zero, so we output the GRC code for “0” (which is just 1, indicating that the value is in the m=0 category; category m=0 has only one element, “0”, so there is no VLI), followed by 0 (the zerotree symbol indicating a zero tree).

For the element “2”, we output the GRC for “2”. Since “2” is in the category m=2, this is 001 (i.e. m zeros followed by 1), and then the VLI (i.e. an m bit number indicating which member of the m-th category it is). After the VLI we output “0” indicating that the tree of descendants from element “2” is also all zero.

For the element “4”, we output the GRC for “4”. Since “4” is in the category m=3, this is 0001 (i.e. m zeros followed by 1), and then the VLI (i.e. an m bit number indicating which member of the m-th category it is). After the VLI we output 1, to indicate that not all descendants of the element “4” are zero.

The element “4” has four direct descendants, “0”, “0”, “1”, “−2”, which we treat in turn.

For the first element “0”, we output the GRC for “0”, which is 1 as explained above, followed by 0, the code indicating that all descendants of this element are also “0”.

For the second element “0”, we output the GRC for “0”, which is 1 as explained above, followed by 0, the code indicating that all descendants of this element are also “0”.

For the element “1”, we output the GRC for “1”, which is 01 (since “1” is in category m=1) followed by the 1 bit VLI. Afterwards we output “0” to indicate that all descendants of this element are zero.

For the element “−2”, we output the GRC for “2”, which is 001 (since “−2” is in category m=2) followed by the 2 bit VLI. Afterwards we output “0” to indicate that all descendants of this element are zero.

This completes the processing of the data structure in FIG. 3(b).

It should be noted that the processing order for siblings in the same generation is not important as long as the compression(encoding) ordering and the decompression(decoding) ordering is preserved.

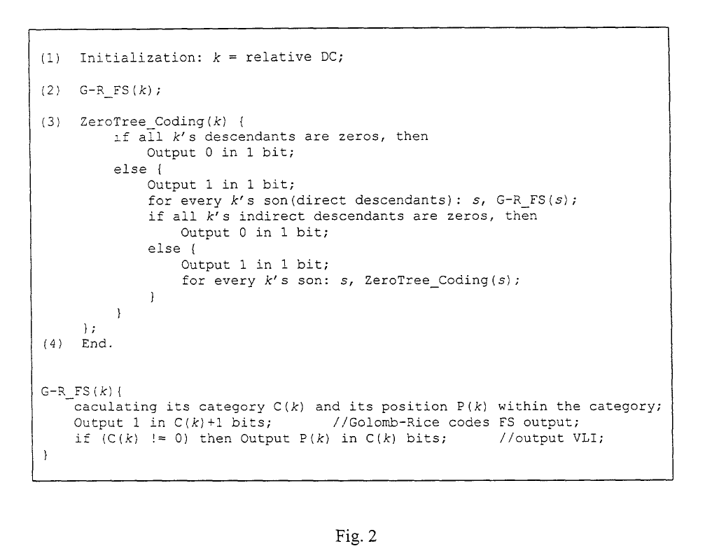

We will now give an algorithmic presentation of the above process. There are two main functions: ZeroTree_Coding( ) and G-R_FS( ) that perform ZTC and G-R_FS/VLI, respectively. The detailed algorithmic description of the embodiment encoder operating on a transformed block is given in FIG. 2, in a terminology obvious to an expert in which, for example, “//” represents a comment.

The application of this algorithm in the case of coding the element “−9” of the data structure of FIG. 3(b), is as follows:

[image]

[image]

[image]

The above example operates in a recursive manner. The processing of G-R_FS(−9) with three direct descendants is explicitly stated above. The processing of G-R_FS(4) with four direct descendants is also explicitly stated above. The processing of G-R_FS(2) and G-R_FS(0) can be referred to how G-R_FS(4) is processed. The operating procedures of ZeroTree_Coding(2) and ZeroTree_Coding(0), which are the same generation sibling as ZeroTree_Coding(4), are not shown in here. However, their implementation will be clear to a skilled person who refers to the description of ZeroTree_Coding(4) in the above example.

The decoding procedure is even simpler than encoding and will be entirely clear to a skilled person, so it is not spelt out here in detail.

D. Computational Complexity and Memory Requirement

In terms of computational complexity, the embodiment is similar to JPEG entropy coding and lower than EZW and SPIHT. In the embodiment, ZTC's computational complexity is comparable to JPEG run length coding. For the remaining coefficients, the embodiment performs straightforward coding by G-R_FS and VLI while JPEG performs Huffman table lookup and VLI. When compared with EZW and SPIHT, the embodiment has lower computational complexity. This is because that the coefficient scanning, tree growing and coding in the embodiment are done in one pass instead of multiple passes on a bit-plane-by-bit-plane basis such as used in EZW and SPIHT and some of their versions involved in extra arithmetic coding.

When comparing memory requirement, we know that in JPEG or MPEG-1/2, there are at least two 16×11 Huffman tables (for luminance and chrominance, respectively) with the longest codeword length of 16-bit. This longest codeword length has been reduced to 12-bit in MPEG-4 and H.263+. For EZW and SPIHT, even without arithmetic coding, the memory requirement doubling the image size is necessary for saving significant/insignificant lists. If arithmetic coding is needed, extra memory will be necessary. However, the embodiment does not require any Huffman table, significant/insignificant list or arithmetic coding, so its memory requirement is minimized.

In terms of uniformity in processing logic, the embodiment deals with relative DCs and ACs in a uniform manner. Furthermore, when this method is varied to be applicable to colour images, this uniform manner is maintained for coding chrominance components. In comparison, JPEG deals with relative DCs and ACs in two different passes. The number of passes is further compounded for coding color images.

In summary, the computational complexity of the embodiment is similar to JPEG entropy coding and lower than EZW and SPIHT. Its memory requirement is minimized with respect to any known image entropy coder. the embodiment is further superior to JPEG in terms of uniformity of processing logic. Therefore, the embodiment is truly a low computational complexity and low memory entropy coder.

2. Experimental Results and Performance Comparisons

The embodiment has been tested on standard grayscale 512×512 Lena and 512×512 Barbara images with DCT and DWT for compression performance. The size of DCT block is set to 8×8. In DWT, 7/9 taps Daubechies filters [25] with six-scale decomposition are utilized resulting in reorganized DWT coefficient block size of 64×64. The uniform+deadzone quantization is applied to both DCT and DWT for uniformity without any further optimization. The deadzone width is set to be 40% larger than that the regular stepsize. The image quality is measured by PSNR which is computed from the actually decoded images.

A. The embodiment with DCT The PSNR results of the version of embodiment using DCT at different bit rates for Lena and Barbara images are given in Table III. In Table II the embodiment is referred to as LLEC (“Low complexity, Low Entropy Coder”).

For comparison purpose, the embodiment versus baseline JPEG (using default Huffman table) and JPEG-O (using adaptive Huffman coding) are also tabulated. JPEG and JPEG-O are taken from http://www.ijg.org/.

In Table III, it can be seen that DCT-based the embodiment consistently outperforms JPEG and JPEG-O. It is superior to JPEG by 1.0 dB on Lena image and 2.2 dB on Barbara image on average. Comparing to JPEG-O, the embodiment gains an average of 0.6 dB on Lena image and 1.7 dB on Barbara image.

TABLE III
DCT-BASED PERFORMANCE COMPARISON (PSNR in [dB])

| | | | |
|---|---|---|---|
| bpp | LLEC | JPEG | JPEG-O |

(a) LENA

| | | | |
|---|---|---|---|
| 0.25 | 31.80 | 30.40 | 31.60 |
| 0.50 | 35.39 | 34.63 | 34.90 |
| 0.75 | 37.40 | 36.52 | 36.60 |
| 1.00 | 38.76 | 37.81 | 37.90 |

(b) BARBARA

| | | | |
|---|---|---|---|
| 0.25 | 26.10 | 24.26 | 25.20 |
| 0.50 | 30.17 | 27.81 | 28.30 |
| 0.75 | 33.02 | 30.72 | 31.00 |
| 1.00 | 35.24 | 33.04 | 33.10 |

B. The Embodiment with DWT

The coding performance of the version of the embodiment using DWT at different bit rates for both Lena and Barbara images is listed in Table IV. In Table IV, the embodiment is compared with EZW (with arithmetic coding) and SPIHT (six-scale decomposition with binary output). SPIHT is taken from http://ipl.rpi.edu/SPIHT.

TABLE IV
DWT-BASED PERFORMANCE COMPARISON (PSNR in [dB])

| | | | |
|---|---|---|---|
| bpp | LLEC | EZW | SPIHT |

(a) LENA

| | | | |
|---|---|---|---|
| 0.0625 | 27.83 | 27.54 | 28.00 |
| 0.125 | 30.51 | 30.23 | 30.71 |
| 0.25 | 33.43 | 33.17 | 33.70 |
| 0.50 | 36.44 | 36.28 | 36.73 |
| 1.00 | 39.42 | 39.55 | 39.91 |

(b) BARBARA

| | | | |
|---|---|---|---|
| 0.0625 | 22.98 | 23.10 | 23.12 |
| 0.125 | 24.44 | 24.03 | 24.47 |
| 0.25 | 26.92 | 26.77 | 27.22 |
| 0.50 | 30.60 | 30.53 | 31.00 |
| 1.00 | 35.18 | 35.14 | 35.94 |

Table IV shows that the embodiment exceeds EZW by an average of 0.2 dB for Lena image and 0.1 dB for Barbara image, respectively. When compared with SPIHT, the embodiment is inferior by 0.3 dB on average for both Lena and Barbara images.

The above description demonstrates that the embodiment is a low-complexity and low-memory entropy coder for image compression. The two key elements in the embodiment are zerotree coding and Golomb-Rice codes. ZTC exploits the zerotree structure of the transformed coefficients for higher compression efficiency. G-R codes instead of Huffman codes are used to code the remaining coefficients in a G-R_FSNLI manner resulting in low-complexity and low-memory. The experimental results show that the compression efficiency of the embodiment (in both the versions based on DCT and DWT) outperforms baseline JPEG and EZW and is slightly inferior to SPIHT. In terms of computational complexity, the embodiment is similar to JPEG entropy coding and lower than EZW and SPIHT. Its memory requirement is minimized with respect to any known image entropy coder. the embodiment is further superior to JPEG in uniformity of processing logic. In addition, the embodiment has other desirable features such as parallel processing support, ROI coding and as a universal entropy coder for DCT and DWT.

Although the invention has been explained with reference to only a single embodiment, many variations are possible within the scope of the invention as will be clear to a skilled person. For example, although in the embodiment employs grayscale image coding, it should be noted that the methods and devices of the present invention are also applicable to color images or video coding.

As a further example, we now consider how the category values can be further compressed, by a process which takes into account the nature (complex or smooth) of the block of an image being encoded.

For example, when using “DCT Quantization step 10” as listed in Table II(a) in used on the 512×512 Lena image, the DCT coefficents are obtained for the 8 by 8 block with top left hand corner position at x=120; y=240 are as shown in FIG. 4. Considering only the application of GRC to code the top left value, “8”, and its three direct descendants “−8”, “−7” and “9”, we get the category bit streams 00001, 00001, 0001, 00001. The total number of bits required to code the four categories according to the embodiment of the invention given above is therefore 19.

However, we can write these four values in the following table, as

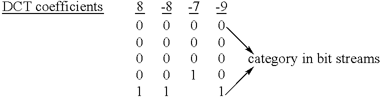

We can then read these bits horizontally, forming the string 0000 0000 0000 0010 111. The left hand of this string is biased to zeros, while the right hand of the string is biased to 1s. There are a variety of known coding schemes to exploit such a distribution.

For example, there is the “zero run length” coding scheme, which is part of JPEG.

The above 19 bit number is encoded as two numbers: “14 zeros and then a numeral ONE” (coding the first 15 bits) and “1 zero and then a numeral THREE” (coding the last 4 bits).

Similarly, encoding the remaining coefficients of FIG. 4, “6”, “−4”, “−7” and “4”, their category values are 0001, 0001, 0001, 0001. Writing these vertically and reading them horizontally (as in the case above), produces the 16 bit bitstream 0000 0000 0000 1111, which can be encoded using the JPEG “zero run length” algorithm using only one set of numbers as “12 zeros followed by a numerical FOUR”.

To recap, our coding scheme produces a combination of ZeroTree Code, NON ZeroTree Code, Category and VLI (associated with Category) for the above 8 DCT coefficients(namely 8, −8, −7, 9; 6, −4, −7, 4). We have already shown that for the 8×8 DCT block(at x=120, y=240) consists of many high magnitude non-zero coefficients. For these high magnitude non-zero coefficients we have shown that we can redistribute the Category bit stream for higher compression efficiency. In the above case, our optimisation is only applied to the category which has more ZEROs and less ONEs in the category bit stream.

The example below shows that we can also optimise when there are many ZEROs in an 8×8 block (typical of a “smooth” image) and that the non-zero coefficients are typically of small magnitude. Our optimisation in the following example is based on more ONEs and less ZEROs in the category bit stream.

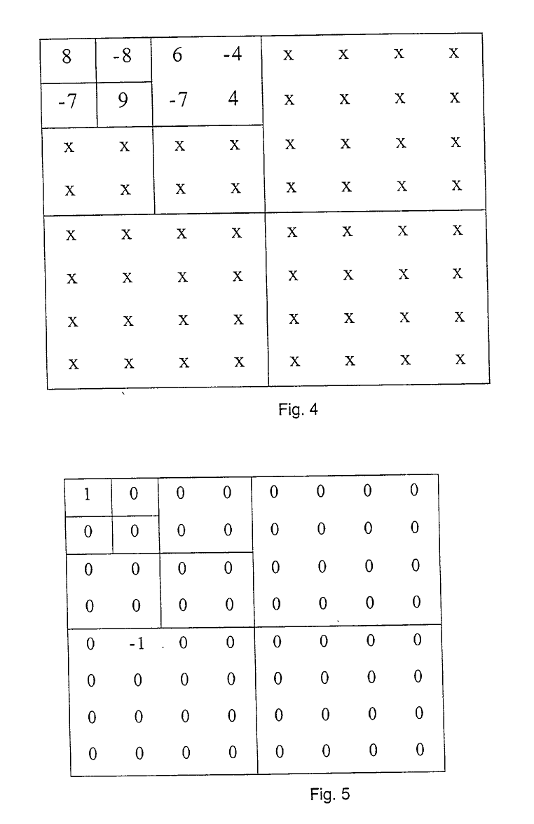

Consider the data structure shown in FIG. 5, which is obtained by using “DCT Quantization step 10” as listed in Table II(a) on the 512×512 Lena image, with the top left hand corner at x=280 and y=496.

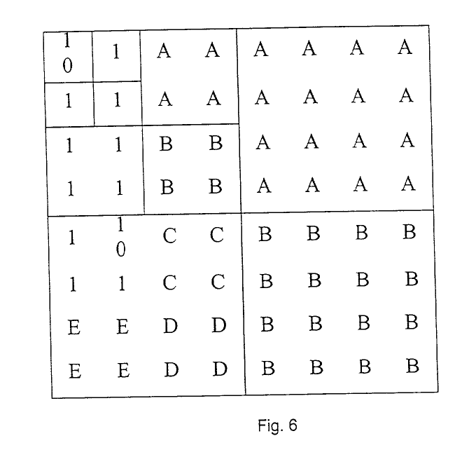

FIG. 6 shows the values of the output of the embodiment of the invention described above with reference to FIG. 2, when applied to the data structure of FIG. 5. Those zero elements of the data structure of FIG. 5 which are encoded as part of the zerotrees are shown with letters A, B, C, D and E. For each of the other elements of the data structure of FIG. 5, one or two bits are given in the corresponding location indicating the corresponding one or two bits by which their values (and the existence of a zerotree below them) are coded.

It can be seen that there are 12 ONEs and 2 ZEROs in the category bit stream. Again, there are a variety of coding techniques for the above desirable distribution. And again, “run length coding” is only one of the many techniques to improve compression efficiency. Our broad concept is not restricted to coding by “run length coding” as there are a variety of ways to harness the desirable distribution with “considerably more ONEs than ZEROs in a bit stream” or “considerable more ZEROs than ONEs in a bit stream” resulting in better compression efficiency.

### References

The following references are incorporated herein in their entirety by reference:

[1] T. Tran and Q. Nguyen, “A Progressive transmission image coder using linear phase uniform filterbanks as block transform,” IEEE Trans. Image Processing, vol. 8, no. 11, pp. 1493-1507, 1999.

[2] W. Pennebaker and J. Mitchell, JPEG Still Image Data Compression Standard. New York: Van Nostrand Reinhold, 1993.

[3] “Coding of moving pictures and associated audio for digital storage media up to about 1.5 Mbits,” Tech. Rep., ISO/IEC IS 11172(MPEG-1), 1993.

[4] “Generic coding of moving pictures and associated audio,” Tech. Rep., ISO/IEC DIS 13818(MPEG-2),1994.

[5] L. Chiariglione, “MPEG and multimedia communications,” IEEE Trans. Circuits Syst. Video Technol., vol. 7, no 1, pp. 5-18, 1997.

[6] T. Sikora, “The MPEG-4 video standard verification model,” IEEE Trans. Circuits Syst. Video Technol., vol. 7, no 1, pp. 19-31, 1997.

[7] F. Pereira and T. Alpert, “MPEG4 video subjective test procedures and results,” IEEE Trans. Circuits Syst. Video Technol., vol. 7, no 1, pp. 32-51, 1997.

[8] “Video codec for audiovisual services at px64 kb/s,” ITU-T Rec. H.261, 1990.

[9] “Video coding for low bit rate communications,” ITU-T Draft Rec. H.263, December 1995.

[10] Z. Xiong, O. Guleryuz, and M. Orchard, “A DCT-based embedded image coder,” IEEE Signal Processing Letters, vol. 3, no. 11, pp. 289-290, 1996.

[11] Z. Xiong, K. Ramchandran, M. Orchard, and Y. Zhang, “A comparative study of DCT- and wavelet-based image coding,” IEEE Trans. Circuits Syst. Video Technol., vol. 9, no 5, pp. 692-695, 1999.

[12] D. Zhao, Y. K. Chan and Y. Lu, “Embedded image coding based on novel organization of DCT coefficients,” Proceedings of SPIE--Application of Digital Image Processing XXIII, vol. 4115, pp. 153-162, USA, 2000

[13] J. Shapiro, “Embedded image coding using zerotree of wavelet coefficients,” IEEE Trans. Signal Processing, vol. 41, no. 12, pp. 3445-3463, 1993.

[14] A. Said and W. Pearlman, “A new, fast, and efficient image codec based on set partitioning in hierarchical trees,” IEEE Trans. Circuits Syst. Video Technol., vol. 6, no 3, pp. 243-250, 1996.

[15] A. Martucci, I. Sodagar, T. Chiang and Y. Zhang, “A zerotree wavelet video coder,” IEEE Trans. Circuits Syst. Video Technol., vol. 7, no 1, pp. 109-118, 1997.

[16] D. Taubman, “High performance scalable image compression with EBCOT,” IEEE Trans. Image Processing, vol. 9, no. 7, pp. 1158-1170, July 2000.

[17] N. Memon, “Adaptive coding of DCT coefficients by Golomb-Rice codes,” Proc. ICIP, vol. 1, pp. 516-520, Chicago, Ill., USA, 1998.

[18] S. Golomb, “Run-length encodings,” IEEE Trans. Inform. Theory, vol. IT-21, pp. 399-401, July 1966.

[19] R. Rice, “Some practical universal noiseless coding techniques—Part I-III,” Tech. Rep. JPL-79-22, JPL-83-17 and JPL-91-3, Jet Propulsion Laboratory, Pasadena, Calif., March 1979, March 1983, November 1991.

[20] M. Weinberger, G. Seroussi, and G. Sapiro, LOCO-I: new developments. ISO Working Document ISO/IEC/JTC1/SC29/WG1 N245, November 1994.

[21] M. Weinberger, G. Seroussi, and G. Sapiro, “LOCO-I: A low complexity, context-based, lossless image compression algorithm,” Proc. Data Compression Conference, A. Storer and M. Cohn, Eds.(Snowbird, Utah), pp. 140-149, IEEE Computer Society Press, 1996.

[22] I. Sodagar, H. Lee, P. Hatrack, and Y. Zhang, “Scalable wavelet coding for synthetic/natural hybrid images,” IEEE Trans. Circuits Syst. Video Technol., vol. 9, no 2, pp. 244-254, 1999.

[23] A. Przelaskowski, “Modifications of uniform quantization applied in wavelet coder,” Proc. Data Compression Conference, A. Storer and M. Cohn, Eds.(Snowbird, Utah), pp. 293-302, IEEE Computer Society Press, 2000.

[24] S. Servetto, K. Ramchandran, and M. Orchard, “Image coding based on a morphological representation of wavelet data,” IEEE Trans. Image Processing, vol. 8, no. 9, pp. 1161-1174, September 1999.

[25] M. Antonini, M. Barlaud, P. Mathieu, and 1. Daubechies, “Image coding using wavelet transform,” IEEE Trans. Image Processing, vol. 1, pp. 205-220, April 1992.

1. A method for compression of a digital image, the method comprising:
transforming the image into a data structure having a parent-child relationship with a plurality of sub-bands;
zerotree encoding the data structure to produce zerotree coded data comprising zerotree symbols representing zerotrees in the data structure and symbols representing the values of remaining elements in the data structure; and
secondary encoding of the values of the remaining elements in the zerotree coded data using Golomb-Rice codes.

2. A method according to claim 1 in which said transformation step is a discrete cosine transform.

3. A method according to claim 1 in which said transformation step is a discrete wavelet transform.

4. A method according to claim 1, claim 2 or claim 3 in which said transformation includes a quantisation.

5. A method according to any preceding claim in which said transformation includes a decorrelation step.

6. A method according to claim 5 in which said decorrelation is performed by differential pulse code modulation.

7. A method according to any preceding claim in which said zerotree encoding is performed in a single pass, rather than by multiple passes on a bit-plane-by-bit-plane basis.

8. A method according to any preceding claim in which a portion of the Golomb-Rice codes are converted into strings which are statistically biased to a first binary value in a first portion and the opposite binary value in a second portion, and the strings are compressed according to the bias.

9. A method according to claim 8 in which the compression algorithm depends upon the smoothness of the image.

10. A method according to claim 8 or claim 9 in which the compression algorithm employs run length coding.

11. A method according to any preceding claim which is performed for successive images of a video sequence.

12. An encoder device for compression of a digital image, the encoder comprising:
a filter for transforming the image into a data structure having a parent-child relationship with a plurality of subbands; and
an encoder for:
zerotree encoding the data structure to produce zerotree coded data comprising zerotree symbols representing zerotrees in the data structure and symbols representing the values of remaining elements in the data structure; and
secondary encoding of the values of the remaining elements in the zerotree coded data using Golomb-Rice codes.

13. An encoder device according to claim 12 in which said filter is arranged to perform a discrete cosine transform.

14. An encoder device according to claim 12 in which said filter is arranged to perform a discrete wavelet transform.

15. An encoder device according to claim 12, claim 13 or claim 14 in which said filter is arranged to perform a quantisation of the transformed image.

16. An encoder device according to any of claims 12 to 15 in which said filter is arranged to perform a decorrelation to form the data structure.

17. An encoder device according to claim 16 in which said filter is arranged to perform decorrelation by differential pulse code modulation.

18. An encoder device according to any of claims 12 to 17 in which said encoder is arranged to perform said zerotree encoding in a single pass, rather than by multiple passes on a bit-plane-by-bit-plane basis.

19. An encoder device according to any of claims 12 to 18 in which the encoder is arranged to convert a portion of the Golomb-Rice codes into strings which are statistically biased to a first binary value in a first portion and the opposite binary value in a second portion, and compress the strings are according to the bias.

20. An encoder device according to claim 19 in which the compression algorithm depends upon the smoothness of the image.

21. An encoder device according to claim 19 or claim 20 in which the compression algorithm employs run length coding.

22. An encoder device according to any of claims 15 to 21 which is performed for successive images of a video sequence.

23. A method for compression of a digital image, the method comprising:
transforming the image into a data structure having a plurality of levels, the elements of each level except the lowest level having a plurality of descendent elements in the next lower level, whereby each element of each level but the lowest level define a tree of descendants, the transformation including a quantisation in which the elements are transformed into integer values in the range −(2^{N}−1) to (2^{N}−1), where N is an integer;
zerotree encoding the data structure to produce zerotree coded data, the zerotree coded data being a bitstream including (a) zerotree symbols indicating that all descendants in the data structure are zero, (b) non-zerotree symbols indicating that there is at least one descendant in the associated tree that is non-zero, (c) representations of the values of respective non-zero elements of the data structure;
secondary encoding of the value representations using N predefined categories labelled by a value of m in the range 0, . . . N, the m-th category being the integer values −(2^{m}−1) to −2^{m}−1 and 2^{m}−1 to 2^{m}−1, the encoding comprising for each represented value:
(i) determining the value of m such that the represented value is in the m-th category (ii) forming a first string of m instances of a first binary value terminated by a single instance of a second binary value, (iii) outputting the first string and a second string of length m representing the value.

24. A method according to claim 23 in which said tree structure has n levels labelled by i=1, . . . , n where n is an integer such as 3,
the elements of the 1-st level representing information over a respective spatial area of the image, and
for all i except i=n, each element of the i-th level of the data structure having descendant elements in the (i+1)-th level representing higher spatial frequency information over to a portion of the area represented by that element of the i-th level.

25. A method according to any preceding claim in which the first strings are converted into third strings which are statistically biased to a first binary value in a first portion and the opposite binary value in a second portion, and the third strings are compressed according to the bias.

26. A method according to claim 25 in which the compression algorithm depends upon the smoothness of the image

27. A method according to claim 25 or claim 26 in which the compression algorithm employs run length coding.

28. An encoder device for compression of a digital image, the device comprising:
a filter for transforming the image into a data structure having a plurality of levels, the elements of each level except the lowest level having a plurality of descendent elements in the next lower level, whereby each element of each level but the lowest level define a tree of descendants, the transformation including a quantisation in which the elements are transformed into integer values in the range −(2^{N}−1) to (2^{N}−1), where N is an integer;
a zerotree encoder for zerotree encoding the data structure to produce zerotree coded data, the zerotree coded data being a bitstream including (a) representations of the values of respective non-zero elements of the data structure, (b) Isolated Zero symbols indicating that respective elements of the data structure are zero but that there is at least one descendant in the associated tree that is non-zero; and (c) Zerotree symbols indicating that respective elements of the data structure are zero, and that all descendants in the associated tree are zero;
a secondary encoder for secondary encoding of the value representations using N predefined categories labelled by a value of m in the range 0, . . . N, the m-th category being the integer values −(2^{m}−1) to −2^{m-1} and 2^{m-1} to 2^{m}−1, the second encoding comprising for each represented value:
(i) determining the value of m such that the represented value is in the m-th category (ii) forming a first string of m instances of a first binary value terminated by a single instance of a second binary value, (iii) outputting the first string and a second string of length m representing the value.

29. An encoder device according to claim 28 in which said filter is arranged to generate the tree structure to have n levels labelled by i=1, . . . , n where n is an integer such as 3,
the elements of the 1-st level representing information over a respective spatial area of the image, and
for all i except i=n, each element of the i-th level of the data structure having descendant elements in the (i+1)-th level representing higher spatial frequency information over to a portion of the area represented by that element of the i-th level.
